(19) United States
(12) Patent Application Publication
(10) Pub. No.: US 2022/0049090 A1
(43) Pub. Date: Feb. 17, 2022

(54) POLYCARBONATE ALLOY AND PREPARATION METHOD THEREOF

(71) Applicant: KINGFA SCI. & TECH. CO., LTD., Guangdong (CN)

(72) Inventors: Yan YANG, Guangdong (CN); Mingkun LI, Guangdong (CN); Xianbo HUANG, Guangdong (CN); Nanbiao YE, Guangdong (CN); Wei TONG, Guangdong (CN); Xiangmao DONG, Guangdong (CN); Junwei AI, Guangdong (CN)

(73) Assignee: KINGFA SCI. & TECH. CO., LTD., Guangdong (CN)

(21) Appl. No.: 17/293,488

(22) PCT Filed: Oct. 30, 2019
(86) PCT No.: PCT/CN2019/114377

§ 371 Date: May 13, 2021

(30) Foreign Application Priority Data
Nov. 13, 2018 (CN) 201811348965.4

(51) Int. Cl. C08L 69/00

(52) U.S. Cl. CPC C08L 69/00

(57) ABSTRACT

The present invention discloses a polycarbonate alloy, including the following components in parts by weight: 80 parts of a polycarbonate; and 5 parts to 30 parts of an ethylene copolymer.

### TECHNICAL FIELD

The present invention relates to the technical field of polymer materials, and particularly relates to a polycarbonate alloy and a preparation method thereof.

### BACKGROUND

Polycarbonate (PC) is an engineering plastic with excellent performances, having an excellent mechanical property and an excellent dimensional stability, and a thermal stability, a weather resistance, a creep resistance, and a heat resistance are good. However, due to the presence of a rigid group in the PC molecular chain, a melt viscosity thereof is high and a molding processability is poor. In addition, due to high rigidity of the PC molecular chain and poor molecular chain mobility, and thus recovery from reversible high-elastic deformation that occurs is poor, which is easy to generate residual internal stress, leading to easy stress cracking of molded articles thereof (The stress cracking is that a solvent penetrates between molecules of an alloy, thereby destroying a structure between the molecules, affecting a molecular force, causing fracture of a large number of the molecules, and finally leading to material cracking, where a chemical reagent does not directly cause a chemical action or a molecular degradation, and in fact, it is the chemical reagent that penetrates into molecular structure and causes damage to the inner molecular force of the polymer chain, thereby accelerating molecular fracture.).

### SUMMARY

An objective of the present invention is to overcome the above technical defects, and to provide a polycarbonate alloy, having the advantages of good processability and a resistance to stress cracking.

Another objective of the present invention is to provide a preparation method of the above-mentioned polycarbonate alloy.

The present invention is realized by the following technical solution.

A polycarbonate alloy includes the following components in parts by weight:

| | |
|---|---|
| a polycarbonate | 80 parts; and |
| an ethylene copolymer | 5 parts to 30 parts. |

Preferably, the polycarbonate alloy includes the following components in parts by weight:

| | |
|---|---|
| the polycarbonate | 80 parts; and |
| the ethylene copolymer | 12 parts to 23 parts. |

The ethylene copolymer is selected from at least one of an ethylene copolymer of acrylic acid, an ethylene-vinyl acetate copolymer, a styrene-butadiene-styrene copolymer, a styrene-ethylene-butadiene-styrene copolymer, and a styrene-ethylene-propylene-styrene copolymer. The ethylene copolymer of acrylic acid is selected from at least one of an ethylene-methacrylic acid copolymer, an ethylene-ethyl acrylate copolymer, and an ethylene-butyl acrylate copolymer.

Preferably, the ethylene copolymer is selected from the ethylene copolymer of acrylic acid.

Another option is that the ethylene copolymer is selected from an ethylene copolymer containing a reactive active group, wherein the ethylene copolymer is selected from at least one of an ethylene copolymer of acrylic acid, an ethylene-vinyl acetate copolymer, a styrene-butadiene-styrene copolymer, a styrene-ethylene-butadiene-styrene copolymer, and a styrene-ethylene-propylene-styrene copolymer, the reactive active group is at least one of a maleic anhydride group and an epoxy group, and a grafting ratio of the reactive active group is 0.1% to 15%.

Preferably, the ethylene copolymer in the ethylene copolymer containing the reactive active group is selected from the ethylene copolymer of acrylic acid.

The polycarbonate is selected from an aromatic polycarbonate, an aliphatic polycarbonate, and an aromatic-aliphatic polycarbonate. Preferably, the polycarbonate has a weight average molecular weight of 18,000 to 28,000.

In parts by weight, further includes 0 part to 10 parts of a processing aid and/or an additive.

A preparation method of the above-mentioned polycarbonate alloy includes the following steps: mixing the polycarbonate, the ethylene copolymer, and the processing aid and/or the additive evenly according to a ratio in a high-speed mixer; then adding into a twin-screw extruder, melt mixing at a temperature of 220° C. to 240° C., and then granulating, cooling and drying to obtain the polycarbonate alloy.

The present invention has the following beneficial effects.

According to the present invention, by adding a certain amount of the ethylene copolymer to the polycarbonate, processability (evaluated jointly by a processing molding cycle and a processing moldability (R angle)) and a stress cracking performance of the polycarbonate are improved. Further, in the present invention the ethylene copolymer of acrylic acid is preferred, thus further improving the processability of the polycarbonate alloy. In summary, the polycarbonate alloy of the present invention has the advantages of good processability and a resistance to stress cracking.

### DETAILED DESCRIPTION

The present invention will be further illustrated below by specific implementations, the following embodiments are preferred implementations of the invention, but the implementations of the present invention are not limited by the following embodiments.

Raw materials of Embodiments and Comparative Examples are commercially available, specifically:

EMA: ethylene-methacrylic acid copolymer;

EEA: ethylene-ethyl acrylate copolymer;

EMA-g-GMA: ethylene-methacrylic acid graft epoxy group (GMA is an epoxy group);

EVA: ethylene-vinyl acetate copolymer;

SEBS: styrene-ethylene-butadiene-styrene copolymer;

PP-g-GMA: polypropylene graft epoxy group;

polycarbonate A: an aromatic polycarbonate with a weight average molecular weight being 28,000;

polycarbonate B: an aliphatic polycarbonate with a weight average molecular weight being 18,000;

polycarbonate C: an aromatic polycarbonate with a weight average molecular weight being 8,000;

polycarbonate D: an aromatic polycarbonate with a weight average molecular weight being 30,000;

anti-aging agent: anti-oxidant: anti-ultraviolet aging agent=1:1.

A preparation method of a polycarbonate alloy in Embodiments and Comparative Examples: a polycarbonate and an ethylene copolymer were mixed evenly according to a ratio in a high-speed mixer; then added into a twin-screw extruder, melt mixed at a temperature of 220° C. to 240° C., and then granulated, cooled and dried to obtain the polycarbonate alloy.

Each test method:

(1) Internal stress test: a sample is soaked in 95% glacial acetic acid for 3 minutes. If there is no swelling and no cracking, it means that a stress cracking resistance is good.

(2) Processing molding cycle:

T=(0.013x+3.6)+(0.0085*m+0.5)+(0.6D²+0.3D)+D²/(α×π²)ln[8/π²×(tc−tm)/(tx−tm)]

x: machine clamping force (tons)

m: total product weight (grams)

D: maximum product wall thickness (mm)

a: thermal diffusivity of rubber material mm² sec⁻¹

tc: melting temperature (° C.)

tm: mold temperature (° C.)

tx: heat deflection temperature (° C.);

(3) Processing moldability (R angle): for an injection molded product, by measuring an R angle of product edge after molding, if the closer the R angle of the product edge after the molding is to a designed R angle, the better the processing moldability is; when the R angle of the product is designed as 10 mm, when a pattern satisfies a range: 10≤R angle≤13 mm, it is considered that the processing moldability is good, and when the R angle>13 mm, it is considered that the processing moldability is poor.

TABLE 1
Each ingredient and ratio (in parts by weight) and each performance test
results of Embodiments and Comparative Examples

| | | Embodi- | Embodi- | Embodi- | Embodi- |
|---|---|---|---|---|---|
| | | ment | ment | ment | ment |
| | | 1 | 2 | 3 | 4 |
| Polycarbonate A, parts | | 80 | 80 | 80 | 80 |
| Polycarbonate B, parts | | — | — | — | — |
| Polycarbonate C, parts | | — | — | — | — |
| Polycarbonate D, parts | | — | — | — | — |
| Ethylene | Species of | | | | |
| copolymer | reactive | — | — | — | — |
| | active | | | | |
| | group | | | | |
| | Content of | — | — | — | — |
| | reactive | | | | |
| | active | | | | |
| | group, % | | | | |
| | Ethylene | EMA | EMA | EMA | EMA |
| | copolymer | | | | |
| | Amount, | 5 | 12 | 15 | 23 |
| | parts | | | | |
| Anti-aging agent | | 0.5 | 0.5 | 0.5 | 0.5 |
| Processing molding | | 32 | 30 | 28 | 28 |
| cycle, s | | | | | |
| R angle, mm | | 12 | 10.5 | 10 | 10 |
| Internal stress test | | no cracking | | | |
| | | Embodi- | Embodi- | Embodi- | Embodi- |
| | | ment | ment | ment | ment |
| | | 5 | 6 | 7 | 8 |
| Polycarbonate A, parts | | 80 | 80 | 80 | 80 |
| Polycarbonate B, parts | | — | — | — | — |
| Polycarbonate C, parts | | — | — | — | — |
| Polycarbonate D, parts | | — | — | — | — |
| Ethylene | Species of | | | | |
| copolymer | reactive | | | | |
| | active | | | | |
| | group | | | | |
| | Content of | — | — | — | — |
| | reactive | | | | |
| | active | | | | |
| | group, % | | | | |
| | Ethylene | EMA | EEA | EVA | SEBS |
| | copolymer | | | | |
| | Amount, | 30 | 15 | 15 | 15 |
| | parts | | | | |
| Anti-aging agent | | 0.5 | 0.5 | 0.5 | 0.5 |
| Processing molding | | 28 | 29 | 30 | 30 |
| cycle, s | | | | | |
| R angle, mm | | 10 | 10 | 12 | 12 |
| Internal stress test | | no cracking | | | |
| | | Embodi- | Embodi- | Embodi- | Embodi- |
| | | ment | ment | ment | ment |
| | | 9 | 10 | 11 | 12 |
| Polycarbonate A, parts | | — | — | — | 80 |
| Polycarbonate B, parts | | 80 | — | — | — |
| Polycarbonate C, parts | | — | 80 | — | — |
| Polycarbonate D, parts | | — | — | 80 | — |
| Ethylene | Species of | — | — | — | GMA |
| copolymer | reactive | | | | |
| | active | | | | |
| | group | | | | |
| | Content of | — | — | — | 0.1 |
| | reactive | | | | |
| | active | | | | |
| | group, % | | | | |
| | Ethylene | EMA | EMA | EMA | EMA |
| | copolymer | | | | |
| | Amount, | 15 | 15 | 15 | 15 |
| | parts | | | | |
| Anti-aging agent | | 0.5 | 0.5 | 0.5 | 0.5 |
| Processing molding | | 29 | 35 | 36 | 33 |
| cycle, s | | | | | |
| R angle, mm | | 10 | 13 | 13 | 12 |
| Internal stress test | | no cracking | | | |
| | | Embodi- | Embodi- | Embodi- | Embodi- |
| | | ment | ment | ment | ment |
| | | 13 | 14 | 15 | 16 |
| Polycarbonate A, parts | | 80 | 80 | 80 | 80 |
| Polycarbonate B, parts | | — | — | — | — |
| Polycarbonate C, parts | | — | — | — | — |
| Polycarbonate D, parts | | — | — | — | — |
| Ethylene | Species of | GMA | GMA | GMA | GMA |
| copolymer | reactive | | | | |
| | active | | | | |
| | group | | | | |
| | Content of | 3 | 10 | 15 | 3 |
| | reactive | | | | |
| | active | | | | |
| | group, % | | | | |
| | Ethylene | EMA | EMA | EMA | EVA |
| | copolymer | | | | |
| | Amount, | 15 | 15 | 15 | 15 |
| | parts | | | | |

| | | | | |
|---|---|---|---|---|
| Anti-aging agent | 0.5 | 0.5 | 0.5 | 0.5 |
| Processing molding | 32 | 30 | 30 | 34 |
| cycle, s | | | | |
| R angle, mm | 12 | 11.5 | 11.5 | 13 |

| Internal stress test | | no cracking | |
|---|---|---|---|
| | | Comparative | Comparative |
| | | Example 1 | Example 2 |
| Polycarbonate A, parts | | 80 | 80 |
| Polycarbonate B, parts | | — | — |
| Polycarbonate C, parts | | — | — |
| Polycarbonate D, parts | | — | — |
| Ethylene | Species of | — | — |
| copolymer | reactive | | |
| | active | | |
| | group | | |
| | Content of | — | — |
| | reactive | | |
| | active | | |
| | group, % | | |
| | Ethylene | — | — |
| | copolymer | | |
| | Amount, | — | — |
| | parts | | |

| | | |
|---|---|---|
| PP-g-GMA | — | 15 |
| Anti-aging agent | 0.5 | 0.5 |
| Processing molding | 48 | 30 |
| cycle, s | | |
| R angle, mm | 18 | 20 |
| Internal stress test | cracking | swelling |

It can be seen from Embodiments 1 to 5 that as an increase of the amount of the ethylene copolymer, processability is improved. In general, when the amount of the ethylene copolymer is 12 parts to 23 parts, an overall performance is relatively good and an industrial application value is relatively high.

It can be seen from Embodiments 3, 6 to 8 that the processability of the polycarbonate alloy added with the ethylene copolymer of acrylic acid is relatively good.

It can be seen from Embodiments 3, 9 to 11 that when the weight average molecular weight of the polycarbonate is within the range of 18,000 to 28,000, a product performance is better.

It can be seen from Comparative Example 1 that without adding the ethylene copolymer, its processability and stress cracking resistance are poor.

It can be seen from Comparative Example 2 that an addition of a traditional compatibilizer PP-g-GMA has a small improvement on the processability and the stress cracking resistance, and even the R angle after the molding is greater than that of Comparative Example 1.

1. A polycarbonate alloy, comprising the following components in parts by weight:

| | |
|---|---|
| a polycarbonate | 80 parts; and |
| an ethylene copolymer | 5 parts to 30 parts. |

2. The polycarbonate alloy according to claim 1, comprising the following components in parts by weight:

| | |
|---|---|
| the polycarbonate | 80 parts; and |
| the ethylene copolymer | 12 parts to 23 parts. |

3. The polycarbonate alloy according to claim 1, wherein the ethylene copolymer is selected from at least one of an ethylene copolymer of acrylic acid, an ethylene-vinyl acetate copolymer, a styrene-butadiene-styrene copolymer, a styrene-ethylene-butadiene-styrene copolymer, and a styrene-ethylene-propylene-styrene copolymer; and the ethylene copolymer of acrylic acid is selected from at least one of an ethylene-methacrylic acid copolymer, an ethylene-ethyl acrylate copolymer, and an ethylene-butyl acrylate copolymer.

4. The polycarbonate alloy according to claim 3, wherein the ethylene copolymer is selected from the ethylene copolymer of acrylic acid.

5. The polycarbonate alloy according to claim 1, wherein the ethylene copolymer is selected from an ethylene copolymer containing a reactive active group, wherein the ethylene copolymer is selected from at least one of an ethylene copolymer of acrylic acid, an ethylene-vinyl acetate copolymer, a styrene-butadiene-styrene copolymer, a styrene-ethylene-butadiene-styrene copolymer, and a styrene-ethylene-propylene-styrene copolymer, the reactive active group is at least one of a maleic anhydride group and an epoxy group, and a grafting ratio of the reactive active group is 0.1% to 15%; and the ethylene copolymer of acrylic acid is selected from at least one of an ethylene-methacrylic acid copolymer, an ethylene-ethyl acrylate copolymer, and an ethylene-butyl acrylate copolymer.

6. The polycarbonate alloy according to claim 5, wherein the ethylene copolymer in the ethylene copolymer containing the reactive active group is selected from the ethylene copolymer of acrylic acid.

7. The polycarbonate alloy according to claim 1, wherein the polycarbonate is selected from an aromatic polycarbonate, an aliphatic polycarbonate, and an aromatic-aliphatic polycarbonate; and the polycarbonate has a weight average molecular weight of 18,000 to 28,000.

8. The polycarbonate alloy according to claim 1, wherein in parts by weight, further comprising 0 part to 10 parts of a processing aid and/or an additive.

9. A preparation method of the polycarbonate alloy according to claim 8, the method comprising the following steps: mixing the polycarbonate, the ethylene copolymer, the processing aid and/or the additive evenly according to a ratio in a high-speed mixer, so as to obtain a mixture; then adding the mixture into a twin-screw extruder, melt mixing at a temperature of 220° C. to 240° C., and then granulating, cooling and drying to obtain the polycarbonate alloy.

10. The polycarbonate alloy according to claim 2, wherein the ethylene copolymer is selected from at least one of an ethylene copolymer of acrylic acid, an ethylene-vinyl acetate copolymer, a styrene-butadiene-styrene copolymer, a styrene-ethylene-butadiene-styrene copolymer, and a styrene-ethylene-propylene-styrene copolymer; and the ethylene copolymer of acrylic acid is selected from at least one of an ethylene-methacrylic acid copolymer, an ethylene-ethyl acrylate copolymer, and an ethylene-butyl acrylate copolymer.

11. The polycarbonate alloy according to claim 10, wherein the ethylene copolymer is selected from the ethylene copolymer of acrylic acid.

12. The polycarbonate alloy according to claim 2, wherein the ethylene copolymer is selected from an ethylene copolymer containing a reactive active group, wherein the ethylene copolymer is selected from at least one of an ethylene copolymer of acrylic acid, an ethylene-vinyl acetate copolymer, a styrene-butadiene-styrene copolymer, a styrene-ethylene-butadiene-styrene copolymer, and a styrene-ethylene-propylene-styrene copolymer, the reactive active group is at least one of a maleic anhydride group and an epoxy group, and a grafting ratio of the reactive active group is 0.1% to 15%; and the ethylene copolymer of acrylic acid is selected from at least one of an ethylene-methacrylic acid copolymer, an ethylene-ethyl acrylate copolymer, and an ethylene-butyl acrylate copolymer.

13. The polycarbonate alloy according to claim 12, wherein the ethylene copolymer in the ethylene copolymer containing the reactive active group is selected from the ethylene copolymer of acrylic acid.

14. The polycarbonate alloy according to claim 2, wherein the polycarbonate is selected from an aromatic polycarbonate, an aliphatic polycarbonate, and an aromatic-aliphatic polycarbonate; and the polycarbonate has a weight average molecular weight of 18,000 to 28,000.

15. The polycarbonate alloy according to claim 2, wherein in parts by weight, further comprising 0 part to 10 parts of a processing aid and/or an additive.

16. A preparation method of the polycarbonate alloy according to claim 15, the method comprising the following steps: mixing the polycarbonate, the ethylene copolymer, the processing aid and/or the additive evenly according to a ratio in a high-speed mixer, so as to obtain a mixture; then adding the mixture into a twin-screw extruder, melt mixing at a temperature of 220° C. to 240° C., and then granulating, cooling and drying to obtain the polycarbonate alloy.
